(19) United States
(12) Patent Application Publication
(10) Pub. No.: US 2016/0047877 A1
(43) Pub. Date: Feb. 18, 2016

(54) Optical Differential Solar Tracking System

(71) Applicant: QBotix, Inc., Menlo Park, CA (US)

(72) Inventors: Salomon J. Trujillo, Redwood City, CA (US); Kevin C. Chu, Mountain View, CA (US)

(21) Appl. No.: 14/459,580

(22) Filed: Aug. 14, 2014

(51) Int. Cl. G01S 3/786

(52) U.S. Cl. CPC G01S 3/7861

(57) ABSTRACT

A system and method of using differential optical signals to track the orientation of a solar surface or surfaces is proposed. Two dispersive prisms or gratings arranged in a mirror-symmetric fashion are used to decompose light into its constituent colors, and the gain of a differential amplifier circuit based on the difference of the frequencies of single color collimated light produced by the two prisms or gratings is used to maintain the on-sun orientation of the solar surface or surfaces. The invention provides for a high-precision, low-cost solar tracking system. Preferably, the signal processing and tracking of solar surfaces is performed by a mobile robot that travels to multiple solar surfaces to minimize cost.

### FIELD OF THE INVENTION

This invention relates generally to optical tracking and tracking systems and methods for ensuring on-sun orientation of a solar surface, and more precisely to systems deploying differential refractometers to determine and track on-sun orientation.

### BACKGROUND ART

Energy derived directly from solar radiation promises to address a number of challenges that humanity is facing. Still, a number of obstacles are preventing more widespread adoption of solar systems. One of these challenges relates to efficient tracking of the sun as it traverses its daily trajectory in the sky.

Solar tracking is needed to obtain maximum insolation of a solar surface or to maintain an intended angle of incidence of solar radiation onto the solar surface. The exact sun tracking tolerances depend on whether the solar surface is a reflecting surface used for sunlight concentration purposes or a photovoltaic surface (PV) that converts sunlight into electrical energy.

There are many ways of tracking sunlight taught in the prior art. U.S. Pat. No. 4,154,219 to Gupta teaches a prismatic solar reflector, wherein a prismatic plate is mounted with its flat face exposed to the sun on a reflector panel for use in a solar energy collection system. The plate includes a plurality of triangular prisms with parallel longitudinal axes shaped to provide total internal reflection of incident light rays. Each prism has a cross section forming a right-angled isosceles triangle with the two equal-length, rear faces of the prism oriented at 45 degrees relative to the front face of the plate. The base of each prism forms or is parallel to a front plate surface which receives incident solar light rays. The rays are transmitted through the plate cross section without refraction in the plane of the cross section to be reflected from the two rear faces and back out the front face toward a solar receiver. The prism material has an index of refraction equal to or greater than the square root of two so that there is total internal reflection from the prism faces. The prismatic plate is mounted on a movable heliostat panel controlled by a tracking system to reflect to a solar receiver. The panel has a fixed axis directed toward a central receiver and a moving axis orthogonal to the fixed axis. The prismatic plate is mounted on the panel with the longitudinal axes of the prisms perpendicular to the moving axis. Tracking is accomplished by adjusting the panel orientation so that the plane of incidence of the incident solar rays is parallel to the longitudinal axes of the prisms and also so that the reflected solar rays intercept the receiver.

U.S. Pat. No. 4,910,395 to Frankel teaches an optical tracking sensor including a three-sides prismatic light splitter, wherein a three-sided transparent pyramid with a sharp vertex is used. The pyramid is used to split the incident beam into three parts, which are transmitted to respective photodetectors. The signals from the photodetectors are used for tracking. This invention makes several important improvements to an optical tracking system. The amount of energy incident on each photodetector is increased by 33% over a known four-detector system. The sensor inherently possesses a point vertex formed by three inclined surfaces, regardless of manufacturing tolerances. This directly contributes to increased sensor accuracy in comparison to known four-sided splitters. By reducing the number of sensors to three, the system's mechanical and electronic size and complexity is reduced.

U.S. Pat. No. 5,144,498 to Vincent teaches a variable wavelength light filter and sensor system, wherein a light filter apparatus is taught. The apparatus receives a light beam having wavelengths in a selected band and disperses the light into a plurality of rays, with each ray having a different wavelength for which the intensity peaks. The peak wavelength varies approximately continuously with displacement of spatial position in a chosen direction along the filter's light-receiving plane.

U.S. Pat. No. 7,235,765 to Clugston teaches a solar sensor including a reflective element to transform the angular response. The sensor utilizes a blocking element and curved reflective element between the sun and a photo-sensitive electronic device to provide high signal levels and the ability to shape the angular response of the overall sensor. A particular angular response can be achieved by combining the attenuating effects of the blocking element with the increased response of the curved reflector. These two elements may be combined into one physical structure, or may be separate. Further, the present invention contemplates the use of multiple blocking elements and multiple reflectors.

A shortcoming of prior art teachings is that they do not provide a low-cost, high-precision optical tracking system to track sunlight. While refractive devices and differential refractometers have been used for many applications, there has not been a cost-efficient and accurate solar tracking system effectively utilizing differential refraction and dispersion of light. The prior art teachings while appropriate for some applications, do not provide approaches that are compatible with low-cost, precision-oriented solar tracking systems that are updated on a periodic basis with minimal resources in order to maximize power output generated from their associated solar panel or the entire solar farm.

For a background in basic optics, the reader is directed to Geometrical and Visual Optics, Second Edition, by Steven Schwartz.

### OBJECTS OF THE INVENTION

In view of the shortcomings of the prior art, it is an object of the present invention to provide low-cost, high-precision solar tracking apparatus and methods that support periodic updates of on-sun orientation with minimal cost of maintenance and operation, without requiring complex computational algorithms of computer or machine vision.

### SUMMARY OF THE INVENTION

The objects and advantages of the invention are secured by an optical differential solar tracking system that uses an optical dispersion assembly having two prisms attached to it in a mirror-symmetric fashion. A mirror-symmetric geometry of the prisms signifies that while one set of corresponding rectangular faces of the prisms face each other, another set of corresponding rectangular faces of the prisms face outward of the optical dispersion assembly towards the sun, and the third set of corresponding rectangular faces of the prisms face inward into the optical dispersion assembly or away from the sun. The inward faces of the prisms are each directed at two optical attachments that gather light rays of constituent colors produced by the prisms as a result of dispersion of solar light incident on the respective sunward faces of the prisms, and consequently select light rays of a single color from the constituent color light rays produced by the prisms. Preferably the, optical attachments further collimate the light rays of a single color selected by them for downstream transmission.

The distal ends of the optical attachments are further connected to two optical links for carrying the single color collimated light rays selected by the optical attachment. In the preferred embodiment, each optical attachment comprises an optical tap for collecting the dispersed light produced by the respective prism, and an optical tube or waveguide that further selects light rays of a single color from the light gathered by the respective optical tap. In alternative embodiments, the optical attachment can be selected as one or a combination of the following optical devices: an optical slit, a pinhole, optical filter, spatial filter, one or more fiber optic tube, or one or more optical waveguide. Other types of optical devices for collecting and carrying light rays of a single color from the light dispersed by the prisms are possible, without deviating from the principles of the invention.

The distal ends of the optical links are connected to two respective photosensors, or two respective sets of photosensors, which convert the light rays carried by the optical links into corresponding electrical signal. The voltage, current or electrical power associated with the electrical signals produced by the photosensors varies according to the frequency or color or wavelength of light rays received by the photosensors and in turn carried by the respective optical links.

The outputs from the two photosensors, or the two sets of photosensors as taught above, are fed to the two inputs of a differential amplifier circuit that produces a gain which varies according to the difference in the strengths of the electric signals at its two inputs. The strength of the electric signals can be measured as electric voltage, electric current or a combination of both (electrical power). Because of the mirror-symmetric arrangement of the prisms in the optical dispersion assembly, as the position of the sun with respect to the system changes, the angle of incidence θ of solar light increases on one prism and decreases on the other, thereby producing a shift in the colors of the constituent light rays produced by the two prisms. This shift in the constituent light rays produced by the two prisms is different for the two prisms because of the difference in the angles of incidence of the solar light on the corresponding sunward faces of the two prisms.

Specifically, the color of the light produced by one prism red-shifts, while the color of the light produced by the other prism blue-shifts, as the position of the sun with respect to the system changes. Since the value of the gain produced by the differential amplifier circuit depends on the values of its two inputs, which in turn depends on the frequencies or colors or wavelengths of the single color light rays selected and carried by respective optical attachements and further carried by respective optical links, this apparatus can be used to track a given orientation of the system with respect to the sun.

Once the above system is rigidly attached to a solar surface or a solar panel or a group of solar surfaces or solar panels, and is calibrated to an on-sun orientation, representing a position of the solar surface or surfaces directly facing the sun so as to maximize the energy produced by the solar surface or surfaces, the system can track the movement of the sun by automatically adjusting its orientation so as to follow or track the gain produced by the differential amplifier in the position when the system was calibrated to its on-sun orientation.

In a preferred embodiment, the entire arrangement can be duplicated so as to produce two such gains, each controlling one axis of orientation of the solar surface, such as its altitude and azimuth orientations, or its horizontal and vertical orientations. In this manner, the system taught by the present invention operates as a dual-axis optical differential solar tracking system. Preferably, the prisms are acrylic in composition, and are equilateral, with a nominal angle (θ) of 60°. Preferably, the output of the differential amplifier is further connected to a processing unit that produces electrical signals according to the value of the gain, for controlling the orientation of the solar surface or surfaces.

The on-sun orientation of a solar surface with the optical dispersion assembly rigidly attached to it as described above, will correspond to the solar surface directly facing the sun and producing maximum electrical energy. Preferably, during such on-sun orientation, the single color light rays selected and carried by the optical attachments, and subsequently carried by the respective optical links, will be approximately in the middle of the visible color spectrum. Preferably, the optical links carrying the light rays from the optical attachments to the photosensors are fiber optic tubes.

In an advantageous embodiment of the invention, the orientation of the solar surface or multiple solar surfaces is controlled by a mobile robot that docks to a docking station connected to the solar surface or surfaces. Such a docking station could be provided for every solar surface or for multiple solar surfaces. In this way, a single mobile robot can control the orientations of many solar surfaces by visiting those solar surfaces and docking with the respective docking stations. In this embodiment, the optical dispersion assembly is rigidly attached to the solar surface with the optical links carrying light signals from the optical links to the mobile robot through the docking station, while the mobile robot contains the photosensors and the differential amplifier circuit and any processing unit or other electrical circuitry required to produce electrical signals based on the gain of the differential amplifier, for controlling the orientation of the solar surface or surfaces.

There are optical and electrical couplings on the docking station such that, when the mobile robot is in its docked position, the optical connection required to carry the light rays carried by the optical links to the photosensors onboard the mobile robot is completed. Further, when the mobile robot is in its docked position, the electrical connection required to carry the electrical signals produced by the differential amplifier circuit or any processing unit or other electrical circuitry onboard the mobile robot, to the drive assembly or assemblies of the solar surface or surfaces, in order to control its or their orientation, is also completed. This way, the same mobile robot can control the orientation of multiple solar surfaces by docking to respective docking stations, receiving the optical signals or light rays produced by the prisms, and in turn transmitting corresponding electrical signals to the drive assemblies of the solar surfaces. In an advantageous embodiment of the invention, the system and its components explained above are duplicated, such that the mobile robot as taught above can control two independent axes of orientation of the solar surface or surfaces. In this manner, the system taught by the present invention operates as a dual-axis optical differential solar tracking system.

Preferably, the docking station has a hood that reduces or prevents the ambient light that might otherwise affect the optical couplings on the docking station once the mobile robot is in its docked position. Such a hood can allow scattering of ambient light around the optical coupling without impacting the optical coupling. In another preferred embodiment of the invention, the electrical connection required to form between the differential amplifier circuit or any processing unit or other electrical circuitry on the mobile robot and the drive assembly or assemblies of the solar surface or surfaces for controlling its or their orientation, is a wireless connection.

Preferably the photosensors receiving the light rays produced by the prisms and carried by the optical links are RGB (Red, Green, Blue) sensors with a spectral range of 640 nm-470 nm. Each photosensor produces an electrical output whose voltage, current or a combination of both, varies according to the frequency (or corresponding wavelength or color) of the light rays received at the input of that photosensor. The differential amplifier circuit receiving the outputs of the photosensors produces an electrical signal at its output whose voltage, current or a combination of both, vary according to the difference in the values of its two inputs.

The methods claimed by the present invention further teach the steps required to operate the differential prismatic solar tracking system of the current invention. In an advantageous embodiment of the invention, a calibration step is performed prior to placing the system in production and subsequently on an as-needed basis, in order to maintain proper operation of the system.

In the calibration step, an alternate method is used to first determine the on-sun orientation of the solar surface or surfaces, representing a position of the solar surface or surfaces that maximizes the energy produced by the solar surface or surfaces. With the apparatus taught above by the present invention rigidly attached to a solar surface, such an alternate method can comprise determining the GPS (Global Positioning System) or Longitude and Latitude coordinates of the location of the solar system, and adjusting the orientation of the solar system to its on-sun orientation according to known altitude and azimuth, or, horizontal and vertical, angles of the sun at that location. Such orientation data values for the sun, for any geographical coordinates of the earth, for specific dates and times, is readily available as will be known to an average person skilled in the art. In another embodiment, such an alternate method may simply comprise a visual step of observing the position of the sun at the location of the solar surface and adjusting its orientation to an on-sun orientation.

Once the on-sun orientation is established using an alternate method in the calibration step, the corresponding gain, or gains in the case of a dual-axis solar tracking system as taught above, are measured and established by the system. These values can be recorded in the processing unit as taught above. Subsequently after the calibration step has been performed, as the position of the sun changes and the value of the gain changes, or the values of the gains in case of a dual-axis system change, the processing unit or other circuitry in the system can automatically adjust the electrical signals sent to the drive assembly or assemblies of the solar surface, so as to maintain or match or track the gain value or values as established in the calibration step, and hence regain the on-sun orientation of the solar surface. Such a system is called a negative feedback loop system, as will be apparent to an average person skilled in the art. In another embodiment of the invention, the matching of the gain as taught above is performed within predetermined bounds so as to accommodate engineering imperfections of the system.

In an advantageous embodiment of the invention, the calibrated gain or gains as taught above, for multiple solar surfaces are recorded by the onboard processing unit or electrical circuitry of a mobile robot which travels to these multiple solar surfaces, docks to the respective docking stations provided with these multiple solar surfaces, and performs the calibration step as taught above. Subsequently after the calibration step, as the position of the sun with respect to these solar surfaces changes, and their orientation is no longer the on-sun orientation with respect to the position of the sun, the mobile robot travels to these multiple solar surfaces on a periodic basis, docks to the respective docking stations, receives the optical signals or light rays from the prisms on the optical dispersion assembly or prism assemblies in a dual-axis solar tracking system as taught above, and transmits the corresponding electrical signals through the docking station to the drive assembly or drive assemblies of the solar surfaces so as to track or match the value of the gain or gains established in the calibration step as taught above, and restores their on-sun orientation. In this manner, the same mobile robot travels to multiple solar surfaces and restores the on-sun orientation of those solar surfaces, thus economizing on the resources required to operate and maintain an array or a farm of solar surfaces or panels.

An alternate embodiment of the invention utilizes diffraction gratings instead of prisms to decompose incident solar light into its constituent colors. In this embodiment, the rest of the apparatus taught above is engineered such that single color light rays are selected from the output of the diffraction gratings and fed into the optical links and subsequently to the rest of the components of the system as per above teachings. Such an embodiment has the promise to further reduce the overall cost of the system.

Clearly, the apparatus and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is a perspective view of the optical differential solar tracking system according to the invention.

FIG. 2 is a left isometric view of the mirror-symmetric arrangement of the prisms in the optical dispersion assembly according to the present invention.

FIG. 3 is the top view of the optical dispersion assembly and its interconnections with the other components of the solar tracking system according to the invention.

FIG. 4 is a top view of the optical dispersion assembly when the sun has moved away from an on-sun orientation according to the invention.

FIG. 5 is a top view of the optical dispersion assembly after the on-sun orientation is regained by the system.

FIG. 6 is a flowchart comprising the steps required to operate the optical differential solar tracking system of the current invention.

FIG. 7 is a perspective view of the solar tracking system according to the invention, showing a mobile robot and the docking station, such that the mobile robot docks to the docking station to control the orientation of one or multiple solar surfaces.

FIG. 8 is a perspective view of the solar tracking system where a single robot visits multiple solar surfaces and controls their orientation.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

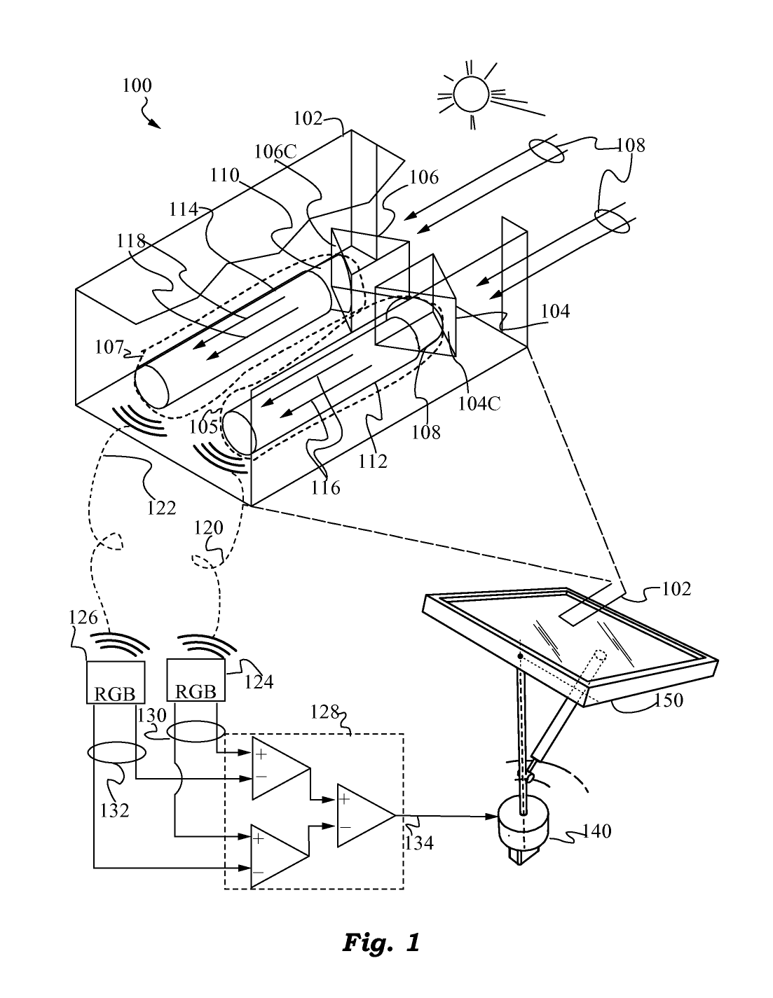

The present invention will be best understood by first reviewing the three dimensional perspective view of a solar tracking system 100 illustrated in FIG. 1. Solar tracking system 100 comprises an optical dispersion assembly 102, shown in left isometric view, with two dispersive prisms 104, 106 attached to it in a mirror-symmetric fashion. A mirror-symmetric arrangement of prisms 104, 106 requires that while one set of corresponding rectangular faces of the prisms face each other, another set of corresponding rectangular faces of the prisms face outward of the optical dispersion assembly towards the sun, and the third set of corresponding rectangular faces of the prisms face inward into the optical dispersion assembly or away from the sun. Such a mirror-symmetric arrangement is shown in more detail in a left isometric view in

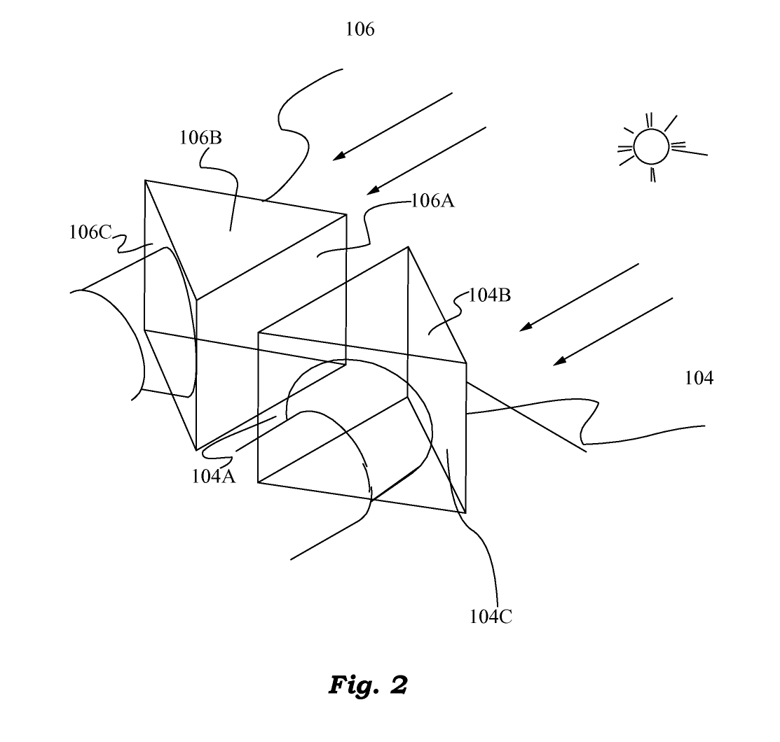

FIG. 2 where rectangular faces 104A, 104B, 104C and 106A, 106B, 106C belonging to prisms 104, 106 respectively are shown. As represented in FIG. 2, rectangular faces 104A and 106A of prisms 104, 106 face each other, while rectangular face 104B, 106B face the sun representing their sunward faces, and rectangular faces 104C, 106C face away from the sun (and into the optical dispersion assembly), representing the inward faces of prisms 104 and 106 respectively. Aside from 3 rectangular faces 104A-C, 106A-C of each prism 104, 106, there are also two additional triangular faces of prisms 104, 106 as shown in FIG. 2. Each such triangular face is also sometimes referred to as the base of the prism, as will be known to those familiar with the art.

Optical dispersion assembly 102 may comprise a cylindrical or a rectangular tube, or another suitable structure that would allow light to only enter from one end, onto sunward faces 104B, 106B of prisms 104, 106. In the preferred embodiment of the current invention, dispersive prisms 104, 106 are composed of acrylic glass and are equilateral prisms, having a nominal angle (θ) of 60°. Thus each base of the prism will form an equilateral triangle as represented in FIG. 2 and as will be obvious to an average person familiar with the art.

Turning our attention to FIG. 1, solar light rays 108 incident on sunward faces 104B, 106B of prisms 104, 106 will be dispersed and decomposed into their constituent colors. Persons skilled in the art will know the basic principles behind the dispersion of light, henceforth summarized for convenience. For a detailed background in the principles of refraction, diffraction and dispersion of light, the reader is directed to the reference cited in the background section of this specification.

Light changes speed as it moves from one medium to another (for example, from air into the glass of the prism). This speed change causes the light to be refracted and to enter the new medium at a different angle as governed by Huygens principle which provides a basis for understanding of wave propagation of light. The degree of bending of the light depends on the angle that the incident beam of light makes with the surface, and on the ratio between the refractive indices of the two media as governed by Snell's law, which explains refraction of light.

The refractive index of many materials, such as glass, varies with the wavelength or color of the light, a phenomenon known as dispersion. This causes light of different colors to be refracted differently and to leave the prism at different angles, creating an effect similar to a rainbow. This can be used to separate a beam of white light into its constituent spectrum of colors. This is fundamentally the basis of the decomposition of light by a dispersive prism into its constituent colors. While the preferred embodiment uses prisms to disperse light into its constituent colors, an alternate embodiment may utilize diffraction gratings to decompose light into its constituent colors, without departing from the principles of the invention. In such an embodiment as claimed by the invention, instead of prism 104, 106 two diffraction gratings will be affixed to optical dispersion assembly 102 in a mirror symmetric fashion. Light dispersed from these grating will be collected by optical attachments 105, 107 which may further collimate these light rays and select light rays of a single color to feed to optical links 120, 122 as taught above.

Referring to FIG. 1, white solar light rays 108 incident on faces 104B, 106B of prisms 104, 106 undergo dispersion and emerge from faces 104C, 106C in the form of their constituent colors. Directed at inward faces 104C, 106C of dispersive prisms 104, 106 are two optical attachments 105, 107 as shown by the dashed lines. Optical attachments 105, 107 can also be attached to inward faces 104C, 106C in alternate embodiments without deviating from the principles of the invention. According to the preferred embodiment shown in FIG. 1, optical attachments 105, 107 are further comprised of optical taps 108, 110. These optical taps are designed to capture the light rays of constituent colors of the visible spectrum emergent from faces 104C, 106C. As will be obvious to an average person of the art, each tap 108, and 110 is also often designed to collimate the light rays it captures. Collimated light rays are parallel and hence spread minimally as they travel through a medium. A collimator is usually shaped like a funnel as represented by the shapes of taps 108, 110.

In the preferred embodiment shown in FIG. 1, optical taps 108 and 110 are respectively connected to optical tubes 112 and 114. As shown in FIG. 1 optical tube 112 selects light rays of a single color from the light rays captured and collimated by tap 108 and previously produced as a result of dispersion of incident solar light 108 by prism 104. Similarly, optical tube 114 selects light rays of a single color from the light rays captured and collimated by tap 110 and previously produced as a result of dispersion of incident solar light 108 by prism 106.

While the following teachings will be provided in the context of the preferred embodiment that uses a combination of optical taps 108, 110 and optical tubes 112, 114 for optical attachments 105, 107 respectively, in alternative embodiments, as will be obvious for persons skilled in the art, optical attachments 105, 107 can comprise a variety of different optical components for the purpose of gathering dispersed light produced by prisms 104, 106, selecting light rays of a single color therefrom, and then optionally collimating those light rays. For example, optical attachments 105, 107 can comprise any one or more of the optical components selected from an optical slit, a pinhole, optical filter, spatial filter, one or more optical tubes or optical waveguides. Other types of optical components can be used for optical attachments 105, 107 within the scope of the current invention.

According to the main embodiment, the distal ends of optical tubes or waveguides 112 and 114 are connected to two optical links 120 and 122 as represented in FIG. 1. The distal ends of optical links 120 and 122 are further connected to two photosensors 124 and 126. Instead of single photosensors 124 and 126, an advantageous embodiment of the invention provides for sets of photosensors (not shown), each such set separately connected to the distal end of each optical link 120 and 122. In the preferred embodiment, photosensors 124, 126 are RGB (Red, Green, Blue) sensors with a spectral range of 470 nm-640 nm. Sensors 124, 126 convert optical signals carried by optical links 120, 122 at the inputs of the sensors to corresponding electrical signals at their outputs 130 and 132 respectively.

According to the invention electrical signals 130, 132 are then provided as inputs to a differential amplifier circuit 128 that produces an electrical gain at its output 134 based on the difference of its inputs 130 and 132. The output of differential amplifier circuit 128 is generally proportional to the difference in the levels of electrical signals 130, 132, as measured by the corresponding voltage, current or a combination of both (electrical power). Thus electrical output 134 is generally proportional to the difference in the frequencies of single color light rays carried by optical links 120 and 122, carried by optical tubes 110 and 114, and in turn selected by optical taps 108 and 112 from the constituent light rays produced by prisms 104 and 106 as a result of dispersion of solar light 108.

It will be apparent to persons with average skill in the art that electrical gain at output 134 of differential amplifier 128 can be measured as an increase or decrease of electrical voltage, current or electrical power (combination of voltage and current). Similarly, the output of each photosensor 124, 126 can be an electrical signal as measured by electrical voltage, current or electrical power, and is based on the frequency (υ), wavelength (λ) or color of single color light rays carried by each optical link 120, 122 to is respective input.

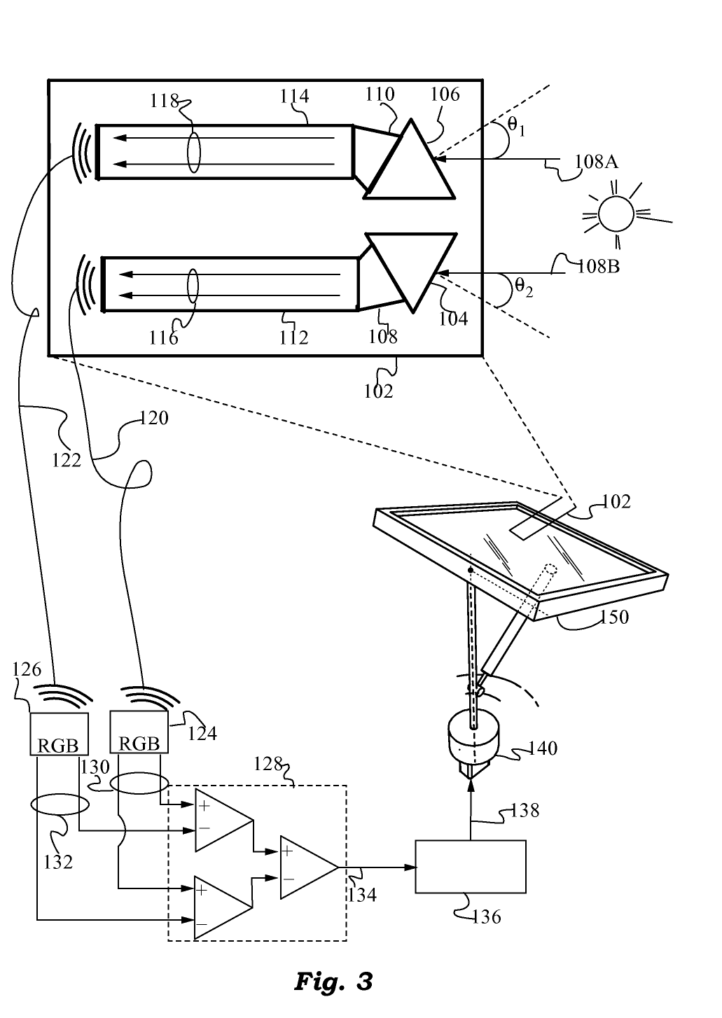

FIG. 3 represents a top view of optical dispersion assembly 102 in two dimensions. In FIG. 3 the angle of incidence θ₁ of light ray 108A on prism 104 is measured as the angle between the ray and an imaginary line normal (perpendicular) to the surface of the prism at the point of incidence of the light ray on the prism surface. Similarly, the angle of incidence θ₂ of light ray 108B on prism 106 is measured as the angle between the ray and an imaginary line normal (perpendicular) to the surface of the prism at the point of incidence of the light ray on the prism surface.

According to the invention, angles of incidence θ₁,θ₂ will be identical when the apparatus is in its on-sun orientation, thereby directly facing the sun. However as the sun moves from the on-sun orientation, there will be an opposing change in the two angles of incidences θ₁ and θ₂. In other words, as the position of the sun with respect to the system changes, angle of incidence θ₁ will increase while angle of incidence θ₂ will decrease. Conversely, angle of incidence θ₁ may decrease while angle of incidence θ₂ may increase. Consequently, according to the invention, the colors of the constituent light rays produced by prisms 104, 106 as a result of dispersion of light 108 will shift in opposing directions of the visible color spectrum. Specifically, the colors of constituent light rays produced by one prism will blue-shift while the colors of constituent light rays produced by the other prism will red-shift.

Indeed this opposing shift in color will be experienced by single color light rays 116, 118 selected by respective optical tubes 112, 114. Specifically, the color of the single color light rays 116 carried by optical tube 112 will blue-shift while the color of the single color light rays 118 carried by optical tube 114 will red-shift as the position of the sun with respect to the system changes. Alternatively, the color of the single color light rays 116 carried by optical tube 112 may red-shift while the color of the single color light rays 118 carried by optical tube 114 may blue-shift as the position of the sun with respect to the system changes.

Since the value of gain at output 134 produced by differential amplifier 128 depends on the values of its inputs 130, 132, which in turn depends on the frequencies or colors or wavelengths of the single color light rays at the inputs of optical sensors 124, 126, carried by respective optical links 120, 122 and previously carried by respective optical tubes 112, 114, this apparatus can be used to track a given orientation of the system with respect to the sun.

The explanation of how this is accomplished is given henceforth. As the position of the sun with respect the apparatus changes, the value of gain at output 134 will change as a result of shift in the color of light rays 116, 118 carried by optical tubes 112, 114 as taught above. If gain at output 134 is partially fed back to differential amplifier circuit 128 in a negative feedback fashion (not shown), and if the gain is used to control the orientation of a solar panel or solar panels, the apparatus will follow the movement of the sun such that a given value of the gain corresponding to a given orientation of the solar panel or solar panels, is maintained by the negative feedback loop (not shown) of differential amplifier circuit 128. It will be apparent to those with average skill in basic electronics the implementation of such a negative feedback amplifier circuit that tracks a net zero gain, or a fixed value gain, by feeding part of the gain back to the input of the amplifier. Therefore, the negative feedback electronic circuitry of differential amplifier 128 is not explicitly shown in FIG. 1 and FIG. 3, and will be apparent to an average person of the art.

A desirable orientation of a solar surface or a panel, or a group of solar surfaces or panels, is the on-sun orientation, which represents a position of the solar surface or surfaces directly facing the sun. The on-sun orientation is desirable because it allows the solar panels to generate maximum electrical power and hence allow a solar farm of such solar panels to yield maximum output, as will be apparent to those with skilled in the art. According to the invention, the apparatus taught above can be used to track or follow the on-sun orientation of solar panels.

This is accomplished by performing an initial calibration step as taught by the methods of the invention. Let us refer to FIG. 3 to understand the calibration step. Optical dispersion assembly 102 is rigidly attached to solar surface 140, or a group of solar surfaces (not shown). The on-sun orientation of solar surface as depicted in FIG. 3 represents a position of optical dispersion assembly 102 directly facing the sun, and angles of incidence θ₁ and θ₂ being equal. This on-sun orientation of solar surface 140 and consequently of optical dispersion assembly 102 is determined using an alternate method.

The invention claims several methods of determining such on-sun orientation using alternate means. A preferred embodiment comprises determining GPS (Global Positioning System) or Longitude and Latitude coordinates of the location of the solar surface or surfaces, and adjusting the orientation of the system to its on-sun orientation according to known altitude and azimuth, or, horizontal and vertical, angles of the sun at that location. Such orientation data values for the sun, for any geographical coordinates of the earth, for specific dates and times, is readily available as will be known to an average person skilled in the art. In another preferred embodiment, such an alternate method comprises a visual step of observing the position of the sun at the location of the solar surface and adjusting its orientation so as to directly face the sun and hence acquire its on-sun orientation.

In this on-sun position, single color light rays 116, 118 will be selected by optical tubes 112, 114 from the constituent light spectrum produced by prisms 104, 106 as a result of dispersion of solar light 108, as taught above. In an advantageous embodiment, in the calibration step whereby the system is in its on-sun orientation, light rays 116, 118 will fall approximately in the middle of the visible spectrum of light colors produced by prisms 104, 106 and hence will be approximately green in color.

As represented in FIG. 3, light rays 116, 118 will travel through optical tubes 112, 114 and will be transmitted over optical links 120, 122 to photosensors 124, 126 which will produce corresponding electrical signals 130, 132 that in turn will serve as inputs to differential amplifier 128. Differential amplifier 128 will produce a gain at its output 134 which will be based on the difference of its inputs 130, 132. It will be obvious that as a result of the on-sun orientation of the apparatus, and the same color of light rays selected and carried by optical tubes 112, 114, the difference in electrical signals at the inputs of differential amplifier will be close to zero, and hence gain at output 134 of differential amplifier 128 will be close to zero.

It will be apparent to those with average skill in the art, that due to engineering differences between photosensors 124 and 126 the difference in electrical signals 130 and 132 may not be exactly zero or close to zero. Similarly, due to the internal bias of amplifier 128, gain at its output 134 may not be zero or close to zero. Indeed, it is conceivable to calibrate the system intentionally in a position that does not represent its on-sun orientation. In such a scenario the calibrated gain may be substantially different from zero. Hence the system as taught above may be used to track an arbitrary orientation of the apparatus with respect to the sun without departing from the principles of the invention.

As shown in FIG. 1 and FIG. 3, drive assembly 140 or assemblies (not shown) control the orientation of solar surface 150, or surfaces (not shown). According to the invention, gain 134 of amplifier 128 is used to control the orientation of solar surface, or surfaces, by delivering appropriate electrical signals to drive assembly 140. In FIG. 1, gain at output 134 is delivered directly to drive assembly 140 without any intervening processing of the electrical signal. In this embodiment, gain at output 134 is partly fed back to the inputs of amplifier 128 in a negative feedback loop (not shown), so as to regain or track its calibrated value.

In the preferred embodiment depicted in FIG. 3, in addition or alternatively to the negative feedback loop (not shown), gain at output 134 is fed to processing unit 136. Processing unit 136 delivers appropriate control signals 138 to drive assembly 140 or assemblies (not shown) for controlling the orientation of solar surface 150 or surfaces (not shown). In this preferred embodiment, processing unit 136 can perform a variety of different functions including recording or storing the calibrated value of gain at output 134 as taught above, and based on stored logic, manipulate its output signals 138 to drive assembly 140 so as to achieve a given orientation of solar surface 140.

It will be apparent to those skilled in the art, processing unit 136 may comprise any number of intervening electrical circuitry or mechanical components between gain at output 134 of differential amplifier 128 and drive assembly 140 of solar surface 150 without departing from the principles of the invention.

A dual-axis solar tracking system is often desirable because it provides better control of the orientation of the solar surface or panel, or group of solar surfaces or panels, to stay closely positioned to their on-sun orientation, thereby maximizing the power output of the individual surfaces and consequently of the entire solar array or solar farm. A highly advantageous embodiment of the invention provides for such a dual-axis solar tracking system, by duplicating the entire apparatus taught above, so as to control two independent axes of control, or axes of orientation, of the solar surface or surfaces.

Referring to FIG. 1 and FIG. 3, in such a dual-axis prismatic solar tracking system, drive assembly 140 or assemblies (not shown) will be dual-axis drive or drives that control the orientation of solar surface 150 or surfaces (not shown) along two different axes. These two different axes of orientation can be the altitude and azimuth orientations, or the horizontal and vertical angles of rotation of solar surface 140 or surfaces (not shown). In this embodiment, with the entire apparatus taught above duplicated, each apparatus will be rigidly attached to each solar surface 150 or a group of solar surfaces (not shown), and will produce a gain at output 134 that will control one axis of orientation of solar surface 150 according to the above teachings.

Let us return our attention to the calibration step taught above as claimed by the methods of the invention. To summarize, in the calibration step gain produced by differential amplifier at its output 134 in response to the on-sun orientation of solar surface 150 is established. In the dual-axis solar tracking embodiment of the current invention, each differential amplifier 128 belonging to each of the duplicated apparatuses of the current invention will produce a gain in response to the on-sun orientation of solar surface 140, and each of these gains will be established in the calibration step. These established values of the gains may also be recorded in processing unit 136 as shown in FIG. 3.

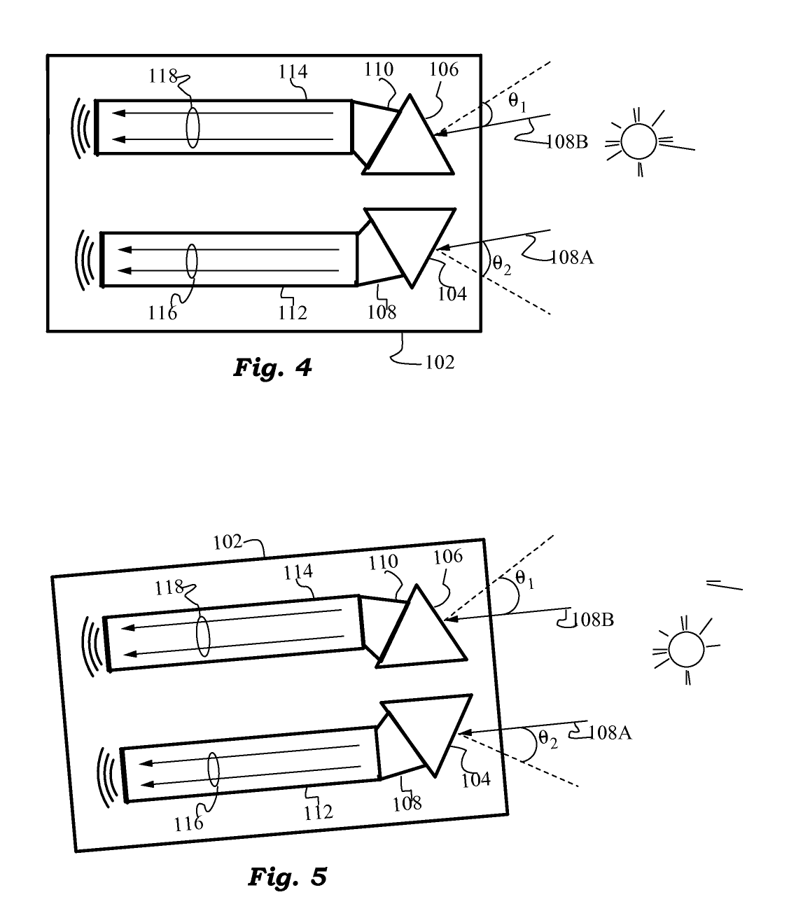

Now, let us understand the operation of the system after the calibration step. FIG. 4 shows optical dispersion assembly 102 of the preferred embodiment of the optical differential solar tracking system of the current invention. For clarity, other components belonging to the system as taught above by the invention have been omitted from this drawing. It is however understood that all necessary components of the system required for implementation and operation of the invention according to its teachings are present, and have been omitted from the drawing for the sake of clarity.

Referring to FIG. 4, as the position of the sun changes from the on-sun orientation of the system when the calibration step was performed, angles of incidence θ₁,θ₂ of solar light rays 108A, 108B are no longer equal. In fact θ₁ is smaller than its value as measured during the calibration step explained above, and as depicted in FIG. 3, while θ₂ is greater than its value as measured during the calibration step explained above. According to the above teachings, single color light rays 116, 118 will either blue-shift or red-shift, resulting in the solar tracking system regaining its orientation as per the measured gain, or gains in the case of the dual-axis solar tracking embodiment of the invention, during the calibration step. Because optical dispersion assembly 102 is rigidly attached to the solar surface or surfaces, it will be rotated along with the solar surface or surfaces by the drive assembly or assemblies of the solar surface or surfaces, restoring the on-sun orientation established in the calibration step. FIG. 5 represents optical dispersion assembly 102 in its restored on-sun orientation, with angles of incidences θ₁ and θ₂ of incident solar light rays 108A and 108B again being equal.

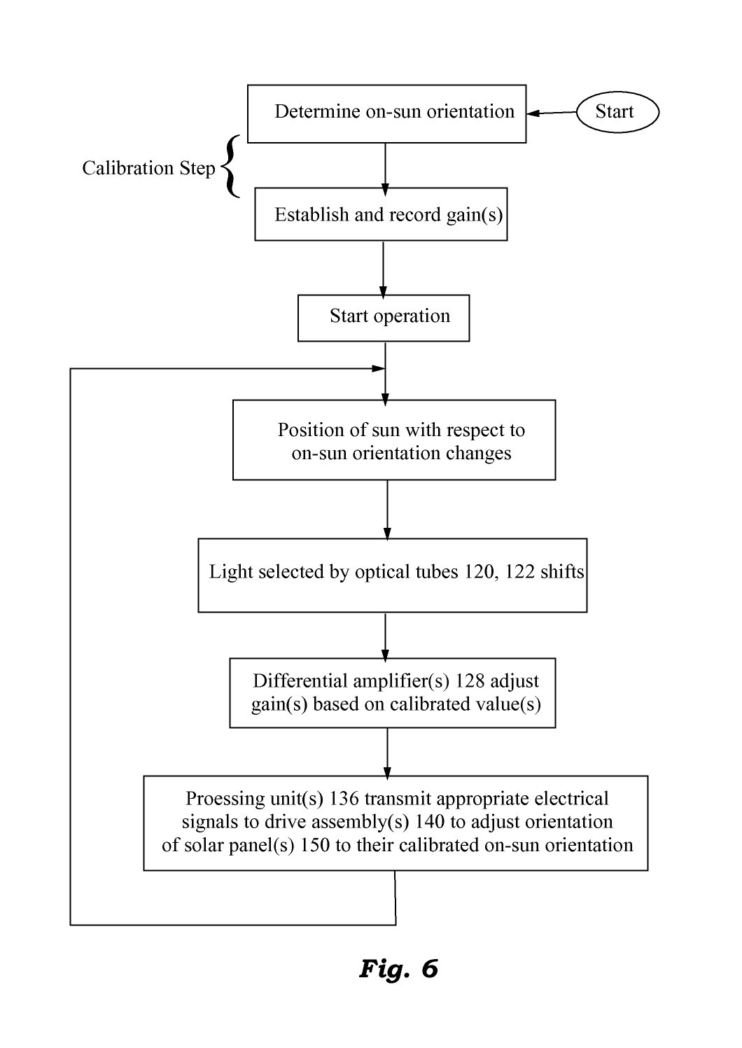

FIG. 6 represents a flowchart of the operation of the system according to the above teachings in an embodiment where a processing unit is used to record gain, or gains in the case of a dual-axis solar tracking system, and provide electrical signals to control the orientation of solar surface or surfaces.

It will be understood by an average person skilled in the art, that based on the characteristics of the electrical, electronic and mechanical components of the system there may be a delay between the time of the movement of the sun to a new position away from the on-sun orientation of the system, to the restoration of the on-sun orientation of the system by its the drive assembly or assemblies. Such a delay will be anticipated in the operation of the system without departing from the principles of the invention.

If will be obvious to an average person of the art, that the calibration step taught above is not necessary for the successful operation of the system. With the gain, or gains in the case of a dual-axis solar tracking embodiment of the current invention, pre-recorded so as to achieve an on-sun orientation of the system, the system can be let to operate, whereby it will regain the on-sun orientation according to the pre-recorded gain or gains. The gain, or gains in case of the dual-axis solar tracking embodiment can be pre-recorded in the processing unit as taught above, or another suitable component of the system. Indeed it is possible to have the pre-recorded gain or gains, correspond to some arbitrary orientation of the system, or any random orientation, and allow the system to go into operation without departing from the principles of the invention. It is further possible to not have any gain or gains pre-recorded in the system, and to not perform the calibration step of above teachings, and still let the system go into operation, without departing from the principles of the invention.

In the preferred embodiment of the current invention, optical links 120 and 122, as depicted in FIG. 1 and FIG. 3, comprise fiber optic tubes or waveguides. Fiber optic tubes are especially suited for transmission of light signals over such distances and conditions as required for the operation of teachings of this invention.

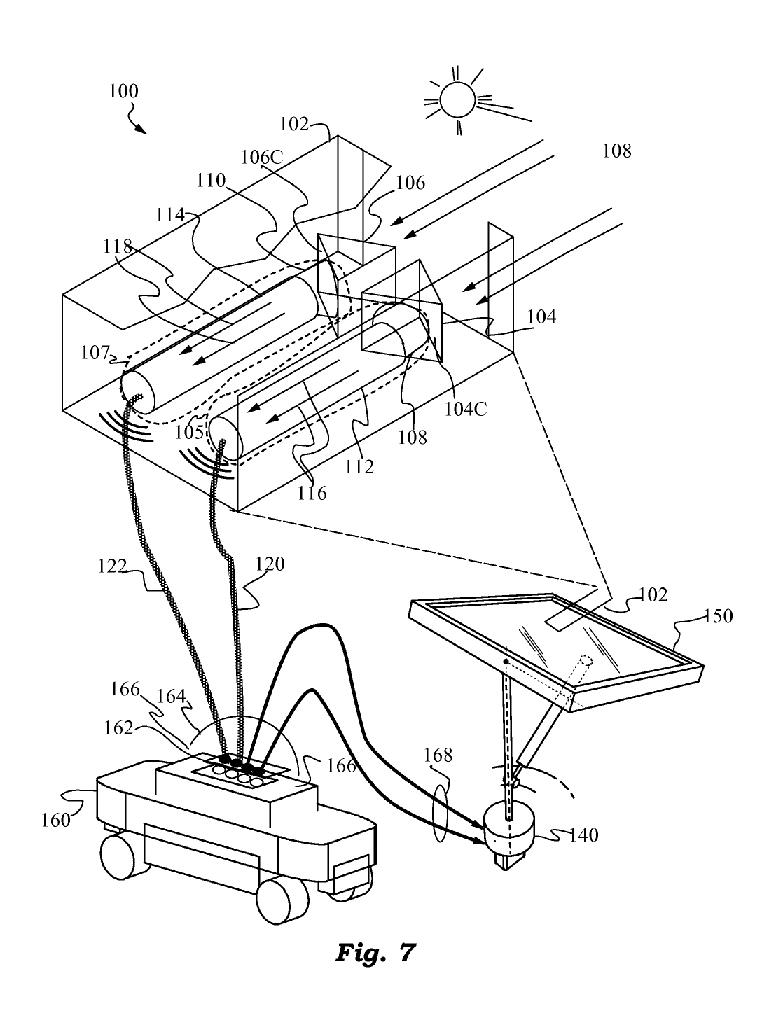

In a highly preferred embodiment of the invention, the orientation of solar surface or groups of solar surfaces is controlled by a mobile robot. This preferred embodiment is represented in FIG. 7, where optical links 120, 122 consist of fiber optic tubes. Mobile robot 160 is connected to solar panel 150 and associated drive assembly 140 or assemblies (not shown), through docking station 162. In this embodiment, optical dispersion assembly 102 with the prisms 104, 106, optical attachments 105, 107 as taught above is rigidly attached to solar surface 150, while the photosensors and the differential amplifier circuit of the system are contained in mobile robot 160. In addition, optical links 120, 122 comprising fiber optic tubes connect the optical tubes carrying single color light rays as taught above, with docking station 162, and electrical links 168 required to deliver electrical signals to drive assembly 140 or assemblies (not shown) in order to control the orientation of solar surface 150 or surfaces (not shown), are also provided at the docking station.

In this embodiment, as shown in FIG. 7, once mobile robot 160 is docked at docking station 162, optical connections carrying light rays from optical tubes of the optical dispersion assembly as taught above to the optical sensors onboard mobile robot 160 are completed by appropriate optical couplings provided on docking station 162. Similarly, electrical connections required to deliver electrical signals produced by the differential amplifier circuit onboard mobile robot 160 to drive assembly 140 or assemblies (not shown), in order to control orientation of solar surface 150 or surfaces (not shown), are also completed by appropriate electrical couplings provided on docking station 162. In this preferred embodiment, any processing unit required to store gain values and manipulate control signals to control drive assembly 140 or assemblies (not shown) may also be onboard mobile robot 160.

In an advantageous embodiment, docking station 162 has a hood 164 that reduces or prevents the ambient light that might adversely affect the optical couplings on the docking station once the mobile robot is in its docked position. Hood 164 can allow scattering of ambient light through gaps 166 between hood 164 and docking station 162 that may arise as a result of engineering imperfections of docking station 162 and hood 164 or because of regular wear and tear from the operation of the system, without adversely affecting the operation of the optical couplings.

Such a design as explained above is easily extended to the dual-axis solar tracking embodiment of the current invention. In such an embodiment, prism assemblies required to control both axes of orientation of solar surface or surfaces will be rigidly connected to the solar surface or surfaces, while photosensors, differential amplifier circuits, and any processing unit or units required to control the two axes of orientation of solar surface 150 or surfaces (not shown) will be onboard mobile robot 160. Similarly, docking station 162 will contain optical couplings required to complete the optical connections for carrying light rays from the optical tubes of the two respective prism assemblies, and electrical connections required to deliver electrical signals to dual-axis drive assembly 140 or assemblies (not shown) to control each axis of orientation of the solar surface or surfaces.

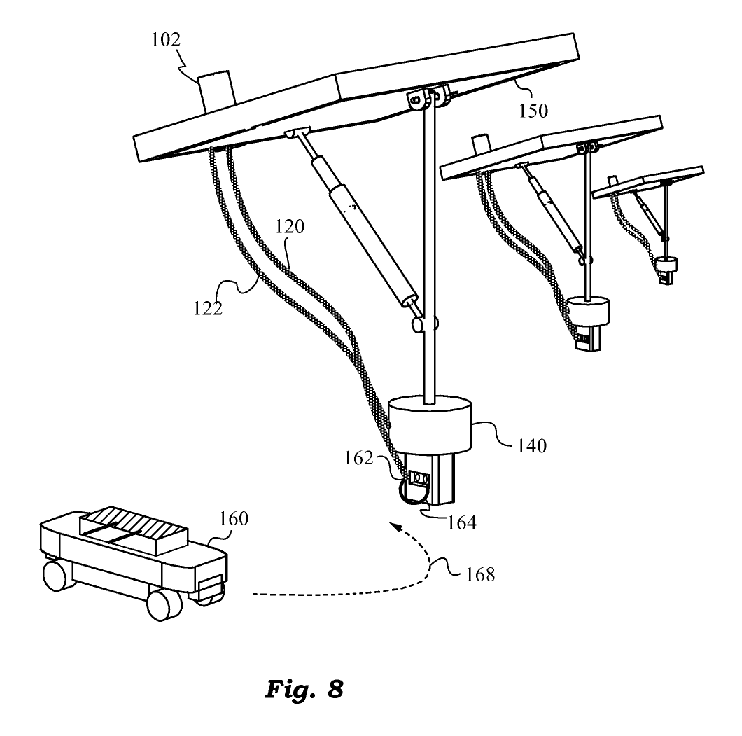

FIG. 8 represents a more pragmatic design of such an embodiment utilizing mobile robot to control the orientation of group of solar surfaces. Mobile robot 160 visits each solar panel 150 or group of panels along path 168 as shown. Docking station 162 is attached at or near the solar panels. Mobile robot 160 arrives at a solar surface 150, docks at docking station 162, thereby completing optical connections of optical links 120, 122 carrying light rays from the attachments 105, 107 and prisms 104, 106 in optical dispersion assembly 102 as taught above. As explained above, the docked position also completes electrical connections required to deliver electrical signals from electrical circuitry onboard mobile robot 160 to drive assembly 140 or assemblies (not shown), to control a single or dual axes of orientation of solar surface 150. Further, hood 164 provides protection from ambient light to the optical couplings in docking station 162. Note it is possible within the teachings of the invention to install optical dispersion assembly 102 only on a subset of solar surface or surfaces of a solar farm, thus economizing costs of deployment and installation of the farm. Similarly, it is possible to have a single drive assembly control more than one solar surfaces in a solar farm, further economizing costs of installation and operation.

In an advantageous embodiment of the invention, the electrical connections required to deliver signals to drive assembly or assemblies of solar surface or surfaces comprise a wireless connection. Several wireless technologies may be suitable for this purpose as will be known to someone skilled in the art. Such a wireless connection can provide several benefits to the installation and operation of the system, including lowering the cost of manufacturing by obviating the need of corresponding electrical links on the mobile robot, solar panels and couplings on the docking station, and lowering the cost of maintenance of the system by reducing wear and tear on electrical wiring. Further, the invention provides the benefit of not requiring any additional or external power source for the operation of the optical differential solar tracking system taught by the invention. Solar energy produced by the solar surfaces will be sufficient to power the electronic and mechanical components of the system according to the above teachings.

In view of the above teaching, a person skilled in the art will recognize that the apparatus and method of invention can be embodied in many different ways in addition to those described without departing from the principles of the invention. Therefore, the scope of the invention should be judged in view of the appended claims and their legal equivalents.

We claim:

1. An optical differential solar tracking system comprising:
a) an optical dispersion assembly comprising two prisms attached to said optical dispersion assembly in a mirror-symmetric fashion, each said prism having a sunward face aimed at the sun, and an inward face aimed at the inside of said optical dispersion assembly;
b) two optical attachments each directed to said inward face of each said prism, each carrying light rays of a single color from the constituent light rays produced by each said prism as a result of dispersion of light incident on said sunward face of each said prism;
c) two optical links, each connected to the distal end of each said optical attachment, each carrying said light rays of a single color;
d) at least one photosensor operably connected to the distal end of the first of each said optical link;
e) at least one photosensor operably connected to the distal end of the second of each said optical link;
f) a differential amplifier circuit, with its first input or first set of inputs operably connected to the output of said photosensor(s) of said element (d);
g) said differential amplifier circuit, with its second input or second set of inputs operably connected to the output of said photosensor(s) of said element (e);
wherein said differential amplifier circuit produces a gain based on the difference in the frequencies of said light rays of a single color carried by said optical links, and wherein said gain is used for controlling at least one axis of orientation of at least one solar surface.

2. The optical differential solar tracking system of claim 1, wherein said optical attachment comprises an optical tap.

3. The optical differential solar tracking system of claim 1, wherein said optical attachment comprises an optical tube.

4. The optical differential solar tracking system of claim 1, wherein said optical attachment comprises a combination of an optical tap and an optical tube.

5. The optical differential solar tracking system of claim 1, wherein said optical attachment is selected from the group consisting of slit, pinhole, optical filter, spatial filter, at least one fiber optic tube, and at least one optical waveguide.

6. The optical differential solar tracking system of claim 1, wherein said light rays are collimated by each said optical attachment.

7. The optical differential solar tracking system of claim 1, wherein said prisms are acrylic in composition.

8. The optical differential solar tracking system of claim 1, wherein said prisms are equilateral, having a nominal angle (θ) of 60°.

9. The optical differential solar tracking system of claim 1, wherein the output of said differential amplifier circuit is further connected to a processing unit that generates electrical signals based on said gain to control said orientation of said at least one solar surface.

10. The optical differential solar tracking system of claim 1 in dual-axis mode, wherein elements (a) through (g) are duplicated and said gain produced by each said differential amplifier circuit of each said set of elements (a) through (g), is used to control one axis of orientation of said at least one solar surface.

11. The dual-axis optical differential solar tracking system of claim 10, wherein said axes of orientation comprise altitude and azimuth orientations of said at least one solar surface.

12. The optical differential solar tracking system of claim 1, wherein said optical dispersion assembly is rigidly attached to said at least one solar surface.

13. The optical differential solar tracking system of claim 1, wherein on-sun orientation of said at least one solar surface, representing a position of said solar surface directly facing the sun, corresponds to solar light being incident as parallel light rays on said sunward face of each said prism.

14. The optical differential solar tracking system of claim 13, wherein in response to said on-sun orientation, said single color light rays carried by each said optical attachment are approximately green in color.

15. The optical differential solar tracking system of claim 1, wherein each said optical link comprises at least one fiber optic tube.

16. The optical differential solar tracking system of claim 1, further comprising:
h) a docking station and a mobile robot that docks itself to said docking station for controlling said orientation of said at least one solar surface;
i) said mobile robot contains said optical sensors, and said optical links connect to said optical sensors through optical couplings on said docking station when said mobile robot is in its docked position;
j) said mobile robot contains said differential amplifier circuit, and electrical circuitry for transmitting electrical signals based on said gain through electrical couplings on said docking station, when said mobile robot is in its docked position, to at least one drive assembly for controlling said orientation.

17. The optical differential solar tracking system of claim 16, wherein said docking station has a hood that minimizes the amount of ambient light falling on said optical coupling.

18. The optical differential solar tracking system of claim 17, wherein said hood allows scattering of ambient light around said optical coupling.

19. The optical differential solar tracking system of claim 16, wherein said electrical coupling comprises a wireless connection between said electrical circuitry and said at least one drive assembly.

20. The solar tracking system of claim 1, wherein each said photosensor is an RGB (Red, Green, Blue) sensor that produces an output signal that varies in accordance with the frequency of said light rays.

21. The solar tracking system of claim 20, wherein each said RGB photosensor has a spectral range of 640 nm-470 nm.

22. The solar tracking system of claim 1, wherein said gain is represented by electrical voltage in the output of said differential amplifier circuit in accordance with the difference in frequencies of said single color light rays carried by each said optical attachment.

23. The solar tracking system of claim 1, wherein said gain is represented by electrical current in the output of said differential amplifier circuit in accordance with the difference in frequencies of said single color light rays carried by each said optical attachment.

24. The optical differential solar tracking system of claim 1, wherein instead of said prisms, two diffraction gratings are used to decompose said solar light into said constituent color light rays, and each said optical attachment carries light rays of a single color from said constituent light rays produced by each said diffraction grating as a result of dispersion of light incident on the sunward face of each said diffraction grating.

25. A method of optical differential solar tracking comprising:
a) providing an optical dispersion assembly with means of attaching two prisms to said optical dispersion assembly in a mirror-symmetric fashion;
b) providing two optical attachments affixed to said optical dispersion assembly for collecting and transmitting light rays of a single color from constituent light rays produced by each said prism when solar light incident on each said prism is dispersed;
c) providing two optical links for carrying said single color light rays carried by each said optical attachment;
d) providing at least one photosensor and means of operably connecting said photosensor(s) to the distal end of the first of each said optical link;
e) providing at least one photosensor and means of operably connecting said photosensor(s) to the distal end of the second of each said optical link;
f) providing a differential amplifier circuit and means of operably connecting the inputs of said differential amplifier circuit to the outputs of said photosensors of each said element (d) and (e), for producing a gain based on the difference in the frequencies of said single color light rays carried by each said optical link;
wherein said gain is used for controlling at least one axis of rotation of at least one solar surface.

26. The method of optical differential solar tracking of claim 25 wherein said optical attachment comprises either one or more of the components selected from the group consisting of optical tap, optical tube, slit, pinhole, optical filter, spatial filter, at least one fiber optic tube, and at least one optical waveguide.

27. The method of solar tracking of claim 25 in dual-axis mode, wherein said steps (a) through (f) are repeated, and said gain produced in each said element (f) is used for controlling one axis of rotation of said at least one solar surface.

28. The method of solar tracking of claim 27, wherein said axes of rotation comprise altitude and azimuth orientations of said at least one solar surface.

29. The method of solar tracking of claim 25, wherein a calibration step is executed by establishing a value of said gain when said at least one solar surface is directly facing the sun, representing its on-sun orientation.

30. The method of solar tracking of claim 29, wherein said on-sun orientation is determined using an alternate apparatus or method.

31. The method of solar tracking of claim 29, wherein said on-sun orientation is determined using GPS (Global Positioning System) coordinates of the location of said at least one solar surface and corresponding known altitude and azimuth angles of the sun at that location.

32. The method of solar tracking of claim 29, wherein said on-sun orientation is determined using latitude and longitude values of the location of said at least one solar surface and corresponding known altitude and azimuth angles of the sun at that location.

33. The method of solar tracking of claim 29, wherein said on-sun orientation is determined using manual means by visually observing the sun and adjusting said orientation.

34. The method of solar tracking of claim 29, wherein electrical energy delivered to at least one drive assembly for controlling said orientation is adjusted such that said gain remains equal to its value as established in said calibration step.

35. The method of solar tracking of claim 29, wherein electrical energy delivered to at least one drive assembly for controlling said orientation is adjusted such that said gain remains approximately equal within pre-determined bounds, to its value as established in said calibration step.

36. The method of solar tracking of claim 25, wherein said step of controlling said orientation is performed by a mobile robot.

37. The method of dual-axis optical differential solar tracking of claim 27, wherein said step of controlling each said axis of rotation is performed by a mobile robot.

38. The method of solar tracking of claim 37, wherein said step of controlling said orientation by said mobile robot is performed when said mobile robot docks to a docking station provided at or near at least one said solar surface, for receiving said single color light rays and controlling said orientation.
